(19) United States
(12) Patent Application Publication
(10) Pub. No.: US 2018/0338885 A1
(43) Pub. Date: Nov. 29, 2018

(54) Cyclical Bicrural Rolling and Kneading Massage Device

(71) Applicant: Dong-Her Wu, Puyen Hsiang (TW)

(72) Inventor: Dong-Her Wu, Puyen Hsiang (TW)

(21) Appl. No.: 15/987,962

(22) Filed: May 24, 2018

(30) Foreign Application Priority Data
May 24, 2017 (TW) 106117152

(51) Int. Cl. A61H 15/00; A61H 23/02

(52) U.S. Cl. CPC A61H 15/0078; A61H 23/0254; A61H 2201/0138; A61H 2015/0042; A61H 2205/106; A61H 2015/0014

(57) ABSTRACT

A cyclical bicrural rolling and kneading massage device comprises a supporting frame, a power unit and two massaging components. Wherein the supporting frame has a bottom portion, an upright column is protruded from the bottom portion, and a hollow tubular rail column is mounted on the bottom portion. The power unit installed inside the rail column is linked to a center shaft bar so that the center shaft bar is actuated to rotate continuously. Each of the massaging components has a rotating block, and a plurality of rollers is pivotally disposed on the rotating block. The rotating block is fixed at a center position of an assembling and connecting section. An eccentric element disposed outwardly from two sides of the rotating block respectively is sleevely assembled at a massaging disk on the assembling and connecting section. A rotating base is disposed on the two massaging disks respectively.

### BACKGROUND OF THE INVENTION

### Field of Invention

The present invention relates to a cyclical bicrural rolling and kneading massage device and more particularly to a legs massage device for cyclically rolling, kneading and massaging on two legs.

### Related Art

In view of conventional massaging devices having the problem that a part of dynamic force is unable to transfer reliably, the inventor of the present invention has invented a cyclical legs massager actuated by a cross screw. The structures are shown in FIGS. 11 to 14, or are disclosed in the patent certificate number I549673 of the Republic of China. The cyclical legs massager comprises a bottom case 50, a power unit 60 and two massaging components 70. Wherein two accommodating portions 51 are disposed above the bottom case 50 provided for human legs to insert into. A first accommodating chamber 52 is formed in the bottom case 50 and at an outer side of the two accommodating portions 51 respectively. A platy slideway 53 is installed obliquely in the two first accommodating chambers 52 respectively. By having the two accommodating portions 51 separated, a second accommodating chamber 54 is formed at a center inside the bottom case 50. The power unit 60 has two opposite case bodies 61. An actuator 62, a drive rod 63 and a cross screw 64 are disposed inside the case body 61. The actuator 62 is a motor that can operate in a forward direction or a reverse direction. The drive rod 63 is protruded from two sides of the case body 61 so that coupling sections 631 protruded from the two sides of the case body 61 are provided for the massaging components 70 to assemble with. The cross screw 64 is penetrated outward from an upper side and a lower side of the case body 61. A gear set 65 is coordinated between the actuator 62 and the drive rod 63 so that the dynamic force of the actuator 62 can be transferred to the drive rod 63. A linkage gear 66 having an internally disposed unilateral bearing (not shown in the figures) is disposed on the cross screw 64. The linkage gear 66 is linked to the gear set 65 so that the linkage gear 66 can be driven on the cross screw 64 by the actuator 62 unilaterally. The power unit 60 is placed inside the bottom case 50 so that the cross screw 64 can be obliquely mounted in the second accommodating chamber 54. Each of the massaging components 70 has a first massaging disk 71, an axle tube 72, a second massaging disk 73, a spring 74 and a stop piece 75 sleevely and sequentially disposed on the coupling section 631 from the inside outward. The stop piece 75 is fixedly disposed at an end of the coupling section 631. The limitation of the stop piece 75 can prevent the first massaging disk 71, the axle tube 72, the second massaging disk 73 and the spring 74 from detaching laterally after being sleeved. By having the spring 74 pressing and supporting between the second massaging disk 73 and the stop piece 75; under normal conditions, the elasticity released by the spring 74 can push the second massaging disk 73 to press against an end of the axle tube 72. The second massaging disk 73 moves outward horizontally when it is exerted with a force so as to compress the spring 74. An outer end of each of the stop pieces 75 is disposed with a rail groove 751 for the slideway 53 to sleevely insert into.

When using the cyclical legs massager, two legs are inserted into the bottom case 50 from the accommodating portions 51 in order that the two legs can lean against and contact with the two massaging components 70. When the actuator 62 turns in a direction, the drive rod 63 can be actuated to rotate through the coordination of the gear set 65, and enables the first massaging disks 71 and the second massaging disks 73 of the two massaging components 70 to rotate and swing continuously for kneading and massaging on the two legs. Through the linkage of the gear set 65, dynamic force can be transferred, and the linkage gear 66 can be driven to turn on the cross screw 64. The case bodies 61, the actuator 62, the drive rod 63 and the gear set 65 of the power unit 60 as well as the two massaging components 70 can operate upward and downward cyclically along the cross screw 64, and thus different parts of the two legs can be massaged and completely relaxed. On the other hand, when the actuator 62 turns in another direction; by taking advantage of the idle of the unilateral bearing inside the linkage gear 66, the dynamic force for actuating the linkage gear 66 to turn can be offset by the unilateral bearing. Therefore, the two massaging components 70 cannot be actuated to move, and enhanced massaging on fixed locations can be achieved.

However, the inventor of the present invention is not satisfied after the above invention was developed. Based on the spirit of striving for improvements and perfection, the inventor is continuously putting his thoughts and mind on researching and developing a structure with features that are more outstanding and easy-to-use. During the subsequent developing process, the inventor has discovered that the structures of the above invention still have the following drawbacks in practical use: 1. the power unit 60 and the massaging components 70 of the cyclical legs massager have to be mounted above the massive bottom case 50 in order to operate, and therefore the costs of usage are high and it occupies more space comparatively; 2. massage protruded dots on the axle tube 72 are protruded directly from a surface of the axle tube 72 and cannot turn on the axle tube 72, and therefore the massage protruded dots are directly rolled on a human body forcibly during usage; the degree of comfort is unsatisfactory, and even more seriously, users may get hurt or injured.

The present invention disclosed herein is provided for improving the structural drawbacks of the inventor's prior art mentioned above.

### SUMMARY OF THE INVENTION

The technical problems sought to be solved:

Improvements are made in view of the conventional massage device previously developed by the present inventor having the above-mentioned problems of high costs of usage, comparative larger occupied space and the massage protruded dots rolling on a human body forcibly.

Technical features for solving the above-mentioned problems:

A cyclical bicrural rolling and kneading massage device of the present invention comprises a supporting frame, a power unit and two massaging components. Wherein the supporting frame has a bottom portion, an upright column is protruded from a top of the bottom portion, and a hollow tubular rail column is mounted on the bottom portion. The rail column has a first end and a second end section. The first end and the second end section of the rail column are respectively linked to the bottom portion and a top end of the upright column so that the rail column is obliquely mounted between the upright column and the bottom portion. A slot hole is penetratingly disposed on two sides of the rail column respectively. The power unit is installed inside the rail column so that the power unit can operate upward and downward reciprocatively, or stop moving at any positions inside the rail column. The power unit is linked to a center shaft bar so that the center shaft bar is actuated to rotate continuously when the power unit is started. By the disposition of the slot hole, an assembling and connecting section disposed respectively at two ends of the center shaft bar can go through the rail column from the slot hole. The assembling and connecting section of each of the two ends of the center shaft bar is provided for installing one of the massaging components. Each of the massaging components has a rotating block, and a plurality of rollers is pivotally disposed on an outer circumference of the rotating block. The rotating block is fixed at a center position of the assembling and connecting section so that the rotating block can move together with the center shaft bar. An eccentric element disposed outwardly from two sides of the rotating block respectively is sleevely assembled at a massaging disk on the assembling and connecting section. A rotating base fixed on the assembling and connecting section is disposed on an outer side of the two massaging disks respectively. A plane surface and an inclined surface are respectively disposed on two sides of the rotating base. The inclined surfaces of the two rotating bases on the same massaging component are oppositely disposed. The inclined surface is provided for the massaging disk to press against. Besides that the massaging disk can maintain at a predetermined eccentric angle by means of the inclined surface, a V-shape is formed between contacting surfaces of the two massaging disks, and can also prevent an oversized gap formed between the massaging disk and the rail column. A plurality of massaging dots is disposed on the contacting surface of the massaging disk. The two massaging disks of each of the massaging components are sleevely and pivotally assembled on the assembling and connecting section by means of installing a bearing. Thereby, the cyclical bicrural rolling and kneading massage device is composed.

Effects in comparison with the prior art:

1. In the cyclical bicrural rolling and kneading massage device of the present invention, the supporting frame is not a massive bottom case that encloses the power unit and the massaging components. Therefore, the cost of usage is low and does not occupy much space comparatively.

2. In the cyclical bicrural rolling and kneading massage device of the present invention, by means of the pivotally assembled rollers and the rotating block; when the rotating block is actuated by the center shaft bar to rotate, the rollers roll over the human body by turning freely instead of the design of directly rolling on the human body forcibly with the massager device. Therefore, it can prevent from hurting or injuring the users, and the comfort during massaging is enhanced.

3. In the cyclical bicrural rolling and kneading massage device of the present invention, the contacting surfaces of the two massaging disks on the same massaging component are separated with the V-shape in between; the continuous offset swinging of the massaging disks with the V-shaped contacting surfaces can sequentially massage with a clamping pressure on the thighs, the low legs, the heels and even the soles of two legs. Therefore, the design is applicable to legs with different thicknesses.

4. In the cyclical bicrural rolling and kneading massage device of the present invention, the two legs are kneaded with a clamping pressure by means of the offset swinging of the massaging disks, and thus the discomfort caused by the massaging disks rolling over the human body forcibly can be avoided.

### BRIEF DESCRIPTION OF THE DRAWINGS

FIG. 1 is a perspective view of a cyclical bicrural rolling and kneading massage device in accordance with the present invention;

FIG. 2 is a sectional view of the cyclical bicrural rolling and kneading massage device in accordance with the present invention;

FIG. 3 is a plane view of the cyclical bicrural rolling and kneading massage device being used;

FIG. 4 is a plane view of massaging components of the cyclical bicrural rolling and kneading massage device moving upward;

FIG. 5 is a plane view of massaging disks at a lower position and at an offset swinging angle;

FIG. 6 is a plane view of the massaging disks at a middle position and at an offset swinging angle;

FIG. 7 is a plane view of the massaging disks at an upper position and at an offset swinging angle;

FIG. 8 is a sectional view of the massaging disks in continuous offset swinging motion;

FIG. 9 is a plane view of the cyclical bicrural rolling and kneading massage device during massaging;

FIG. 10 is a sectional view of another embodiment in accordance with the present invention;

FIG. 11 is a perspective assembly view of an prior art;

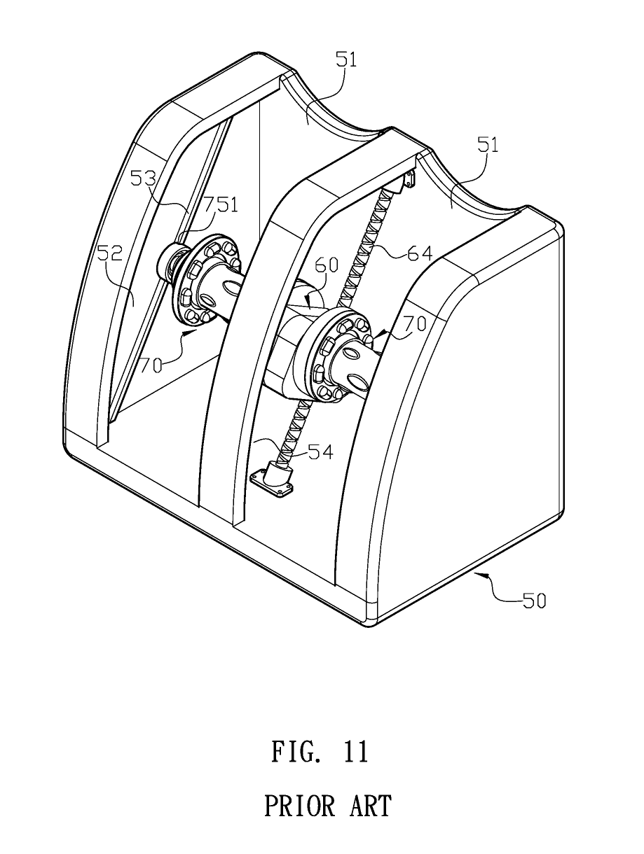

FIG. 12 is a perspective exploded view of the prior art;

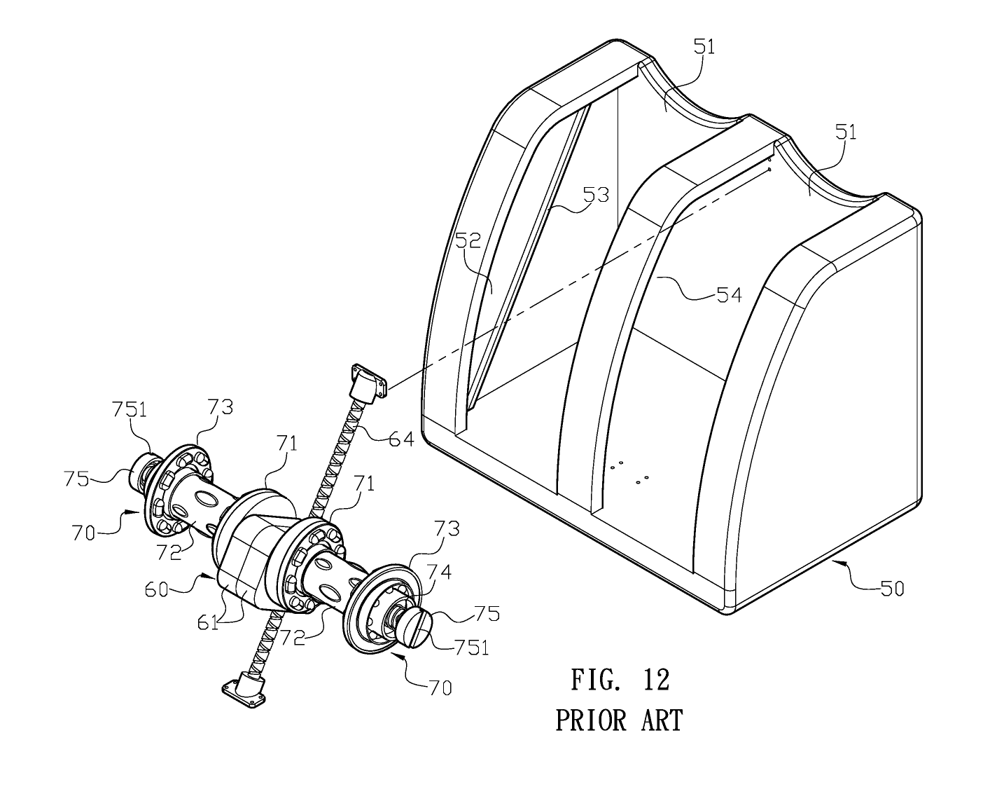

FIG. 13 is a perspective detailed exploded view of the prior art; and

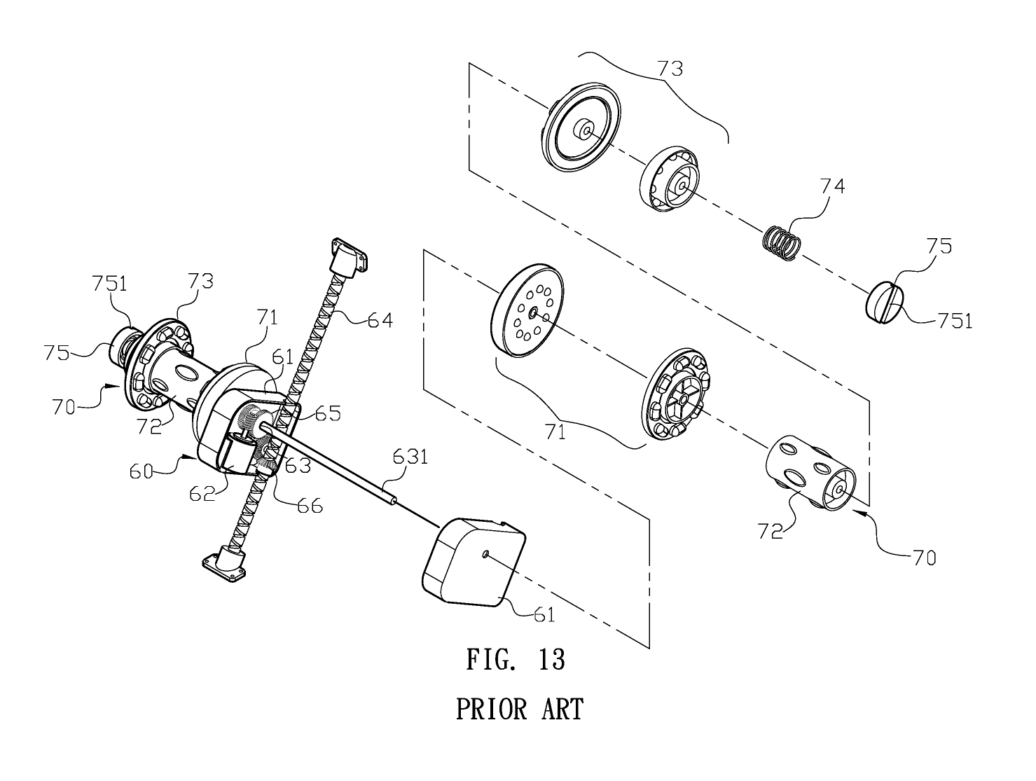

FIG. 14 is a sectional assembly view of the prior art.

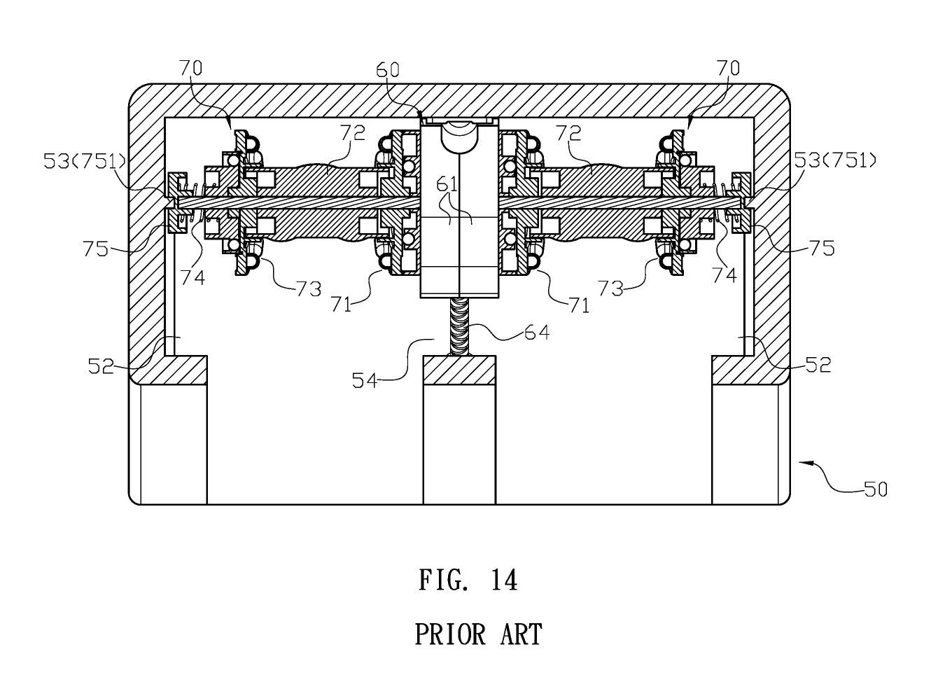

### DETAILED DESCRIPTION OF THE INVENTION

The structure and the technical means adopted by the present invention to achieve the above and other objects can be best understood by referring to the following detailed description of the preferred embodiments and the accompanying drawings. However, the present invention is not limited by the preferred embodiments.

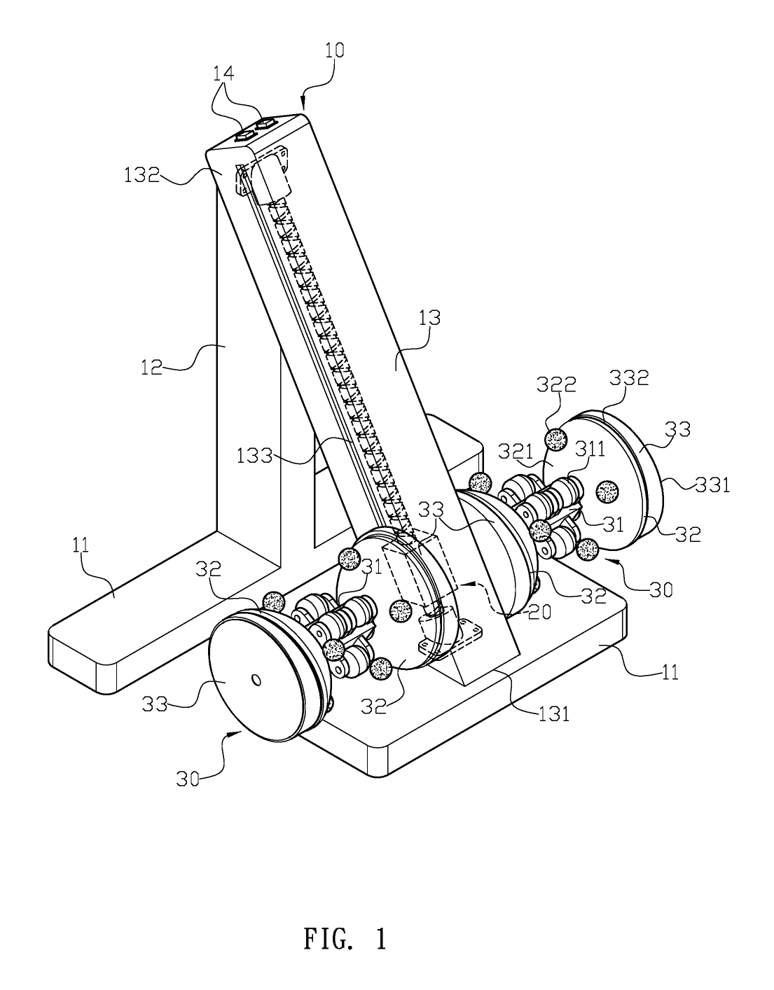

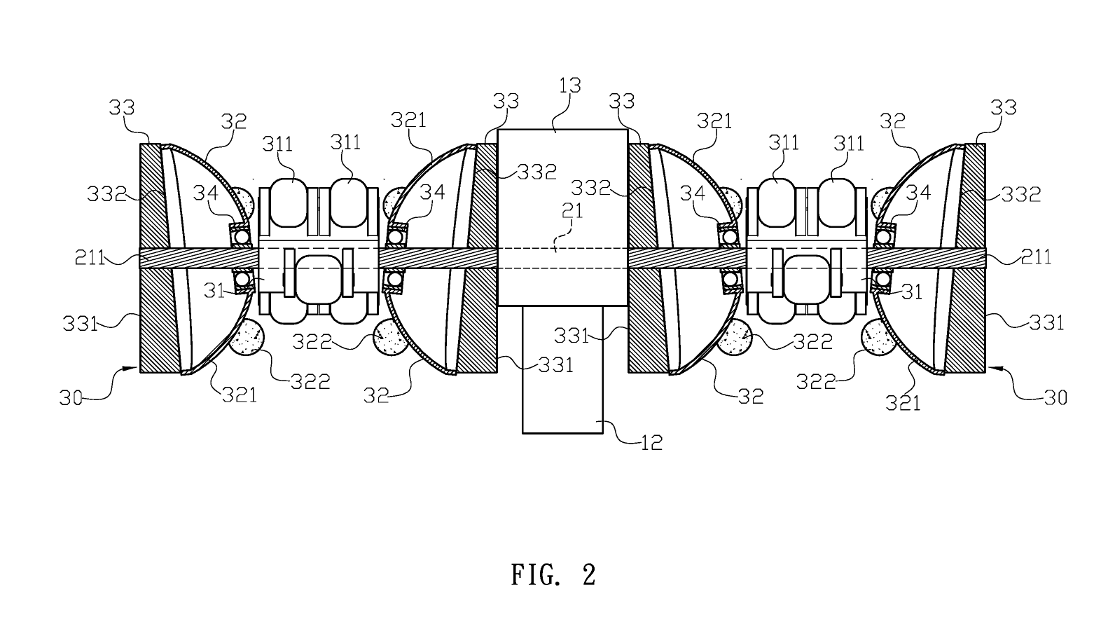

As shown in FIGS. 1 and 2, a cyclical bicrural rolling and kneading massage device of the present invention comprises a supporting frame 10, a power unit 20 and two massaging components 30. Wherein the supporting frame 10 has a bottom portion 11, an upright column 12 is protruded from a top of the bottom portion 11, and a hollow tubular rail column 13 is mounted on the bottom portion 11. The rail column 13 has a first end 131 and a second end section 132. The first end 131 and the second end section 132 of the rail column 13 are respectively linked to the bottom portion 11 and a top end of the upright column 12 so that the rail column 13 is obliquely mounted between the upright column 12 and the bottom portion 11. A slot hole 133 is penetratingly disposed on two sides of the rail column 13 respectively. The power unit 20 is installed inside the rail column 13 so that the power unit 20 can operate upward and downward reciprocatively, or stop moving at any positions inside the rail column 13. The power unit 20 is linked to a center shaft bar 21 so that the center shaft bar 21 is actuated to rotate continuously when the power unit 20 is started. By the disposition of the slot hole 133, an assembling and connecting section 211 disposed respectively at two ends of the center shaft bar 21 can go through the rail column 13 from the slot hole 133. The assembling and connecting section 211 of each of the two ends of the center shaft bar 21 is provided for installing one of the massaging components 30. Each of the massaging components 30 has a rotating block 31, and a plurality of rollers 311 is pivotally disposed on an outer circumference of the rotating block 31. The rotating block 31 is fixed at a center position of the assembling and connecting section 211 so that the rotating block 31 can move together with the center shaft bar 21. An eccentric element disposed outwardly from two sides of the rotating block 31 respectively is sleevely assembled at a massaging disk 32 on the assembling and connecting section 211. A rotating base 33 fixed on the assembling and connecting section 211 is disposed on an outer side of the two massaging disks 32 respectively. A plane surface 331 and an inclined surface 332 are respectively disposed on two sides of the rotating base 33. The inclined surfaces 332 of the two rotating bases 33 on the same massaging component 30 are maintained oppositely disposed. The inclined surface 332 is provided for the massaging disk 32 to press against. Besides that the massaging disk 32 can maintain at a predetermined eccentric angle by means of the inclined surface 332, a V-shape is formed between contacting surfaces 321 of the two massaging disks 32, and can also prevent an oversized gap formed between the massaging disk 32 and the rail column 13. A plurality of massaging dots 332 is disposed on the contacting surface 321 of the massaging disk 32. The two massaging disks 32 of each of the massaging components 30 are sleevely and pivotally assembled on the assembling and connecting section 211 by means of installing a bearing 34.

The cyclical bicrural rolling and kneading massage device provided by the present invention, wherein at least two switches 14 are disposed on the second end section 132 of the rail column 13, and the two switches 14 are used to control the power unit 20 to start or turn off, or stop moving at any positions respectively.

The cyclical bicrural rolling and kneading massage device provided by the present invention, wherein a cross screw and a gear motor are coordinately disposed in the power unit 20. Through the gear motor operating in a forward direction or a reverse direction, the gear motor can move upward and downward reciprocatively, or stop moving at any positions on the cross screw. The gear motor is linked to the center shaft bar 21 so that the center shaft bar 21 is actuated to rotate continuously when the gear motor is started.

The cyclical bicrural rolling and kneading massage device provided by the present invention, wherein the massaging disk 32 is a bowl-shaped structure so that the arcuate contacting surfaces 321 of the two massaging disks 32 on the same massaging component 30 can maintain oppositely disposed.

The cyclical bicrural rolling and kneading massage device provided by the present invention, wherein the soft massaging dots 332 are fixedly disposed on the contacting surface 321 of the massaging disk 32.

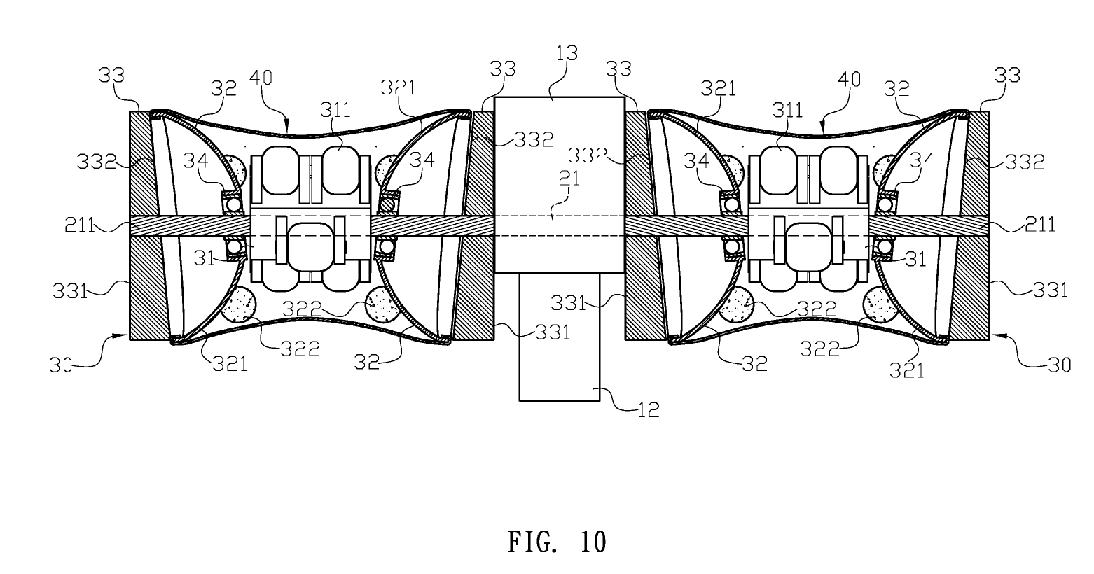

The cyclical bicrural rolling and kneading massage device provided by the present invention, wherein a cloth cover 40 is coupled between the two massaging disks 32 of the same massaging component 30. The cloth cover 40 covers the two massaging disks 32 and rotating block 31 of the same massaging component 30 (please refer to FIG. 10).

The cyclical bicrural rolling and kneading massage device provided by the present invention, wherein a side of the cloth cover 40 is turned over from a gap formed between the massaging disk 32 and rotating base 33, and then coupled with the massaging disk 32 (please refer to FIG. 10).

The cyclical bicrural rolling and kneading massage device provided by the present invention, wherein the bearing 34 is an eccentric bearing.

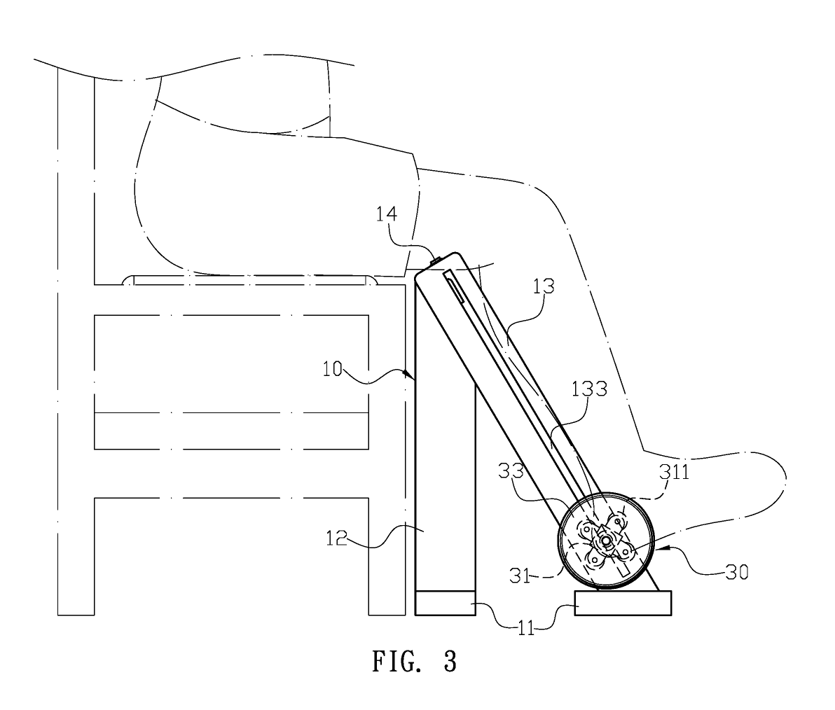

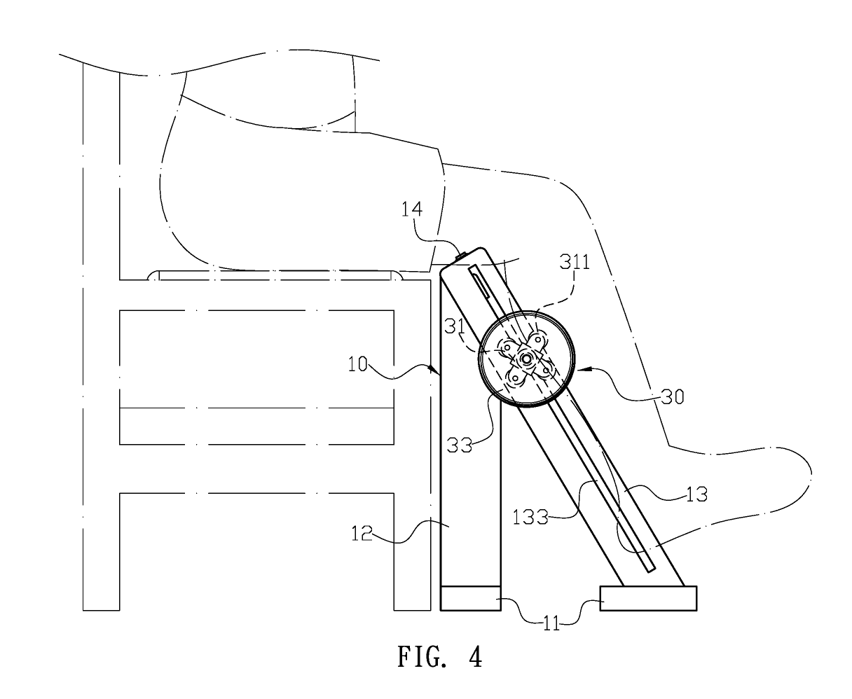

When using the cyclical bicrural rolling and kneading massage device, the two legs are leaned against the two massaging components 30 (please refer to FIG. 3). The two massaging components 30 are actuated by the power unit 20 to massage the thighs, the low legs, the heels and the soles of the two legs by moving upward and downward reciprocatively (please refer to FIG. 4), or to stop moving at any positions. During the stop, enhanced massaging on fixed positions can be achieved. By means of the pivotally assembled rollers 311 and the rotating block 31; when the rotating block 31 is actuated by the center shaft bar 21 to rotate, the rollers 311 roll over the human body by turning freely instead of the design of directly rolling on the human body forcibly.

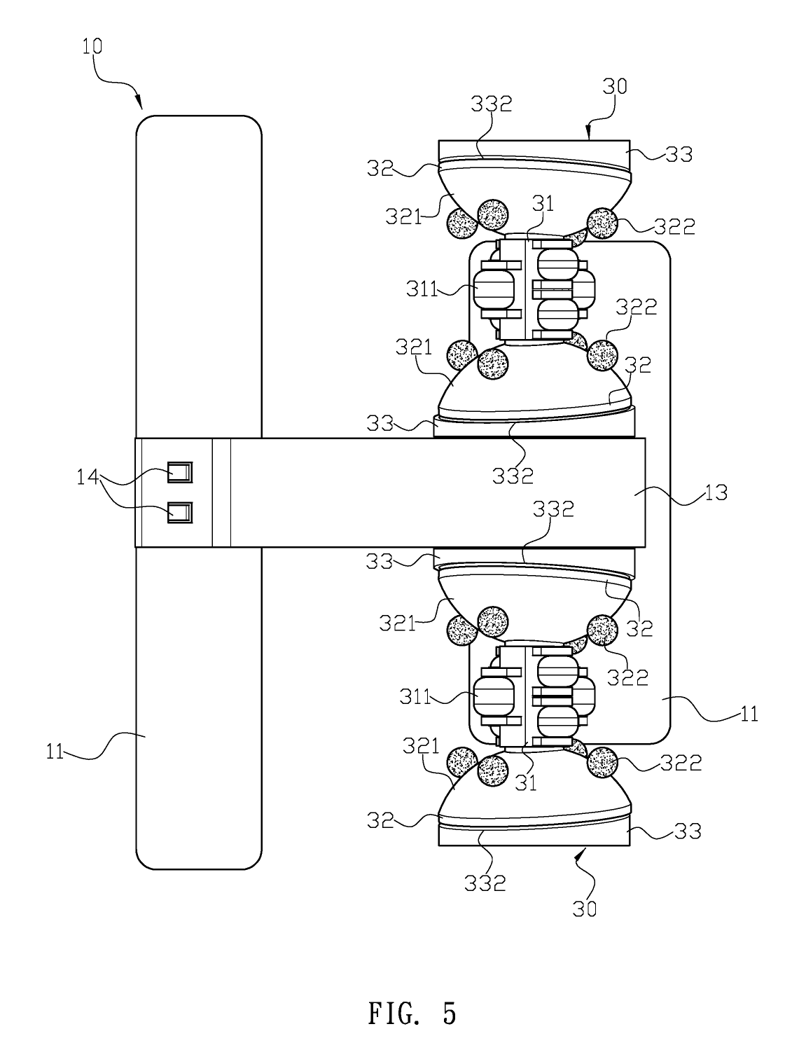

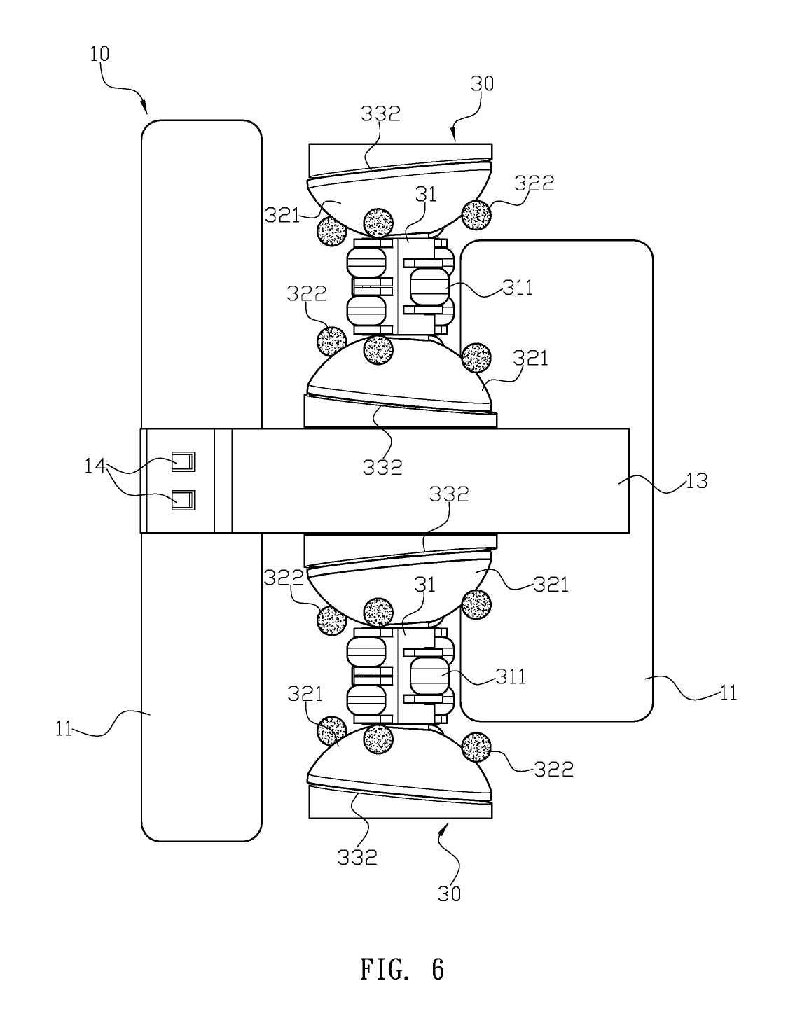

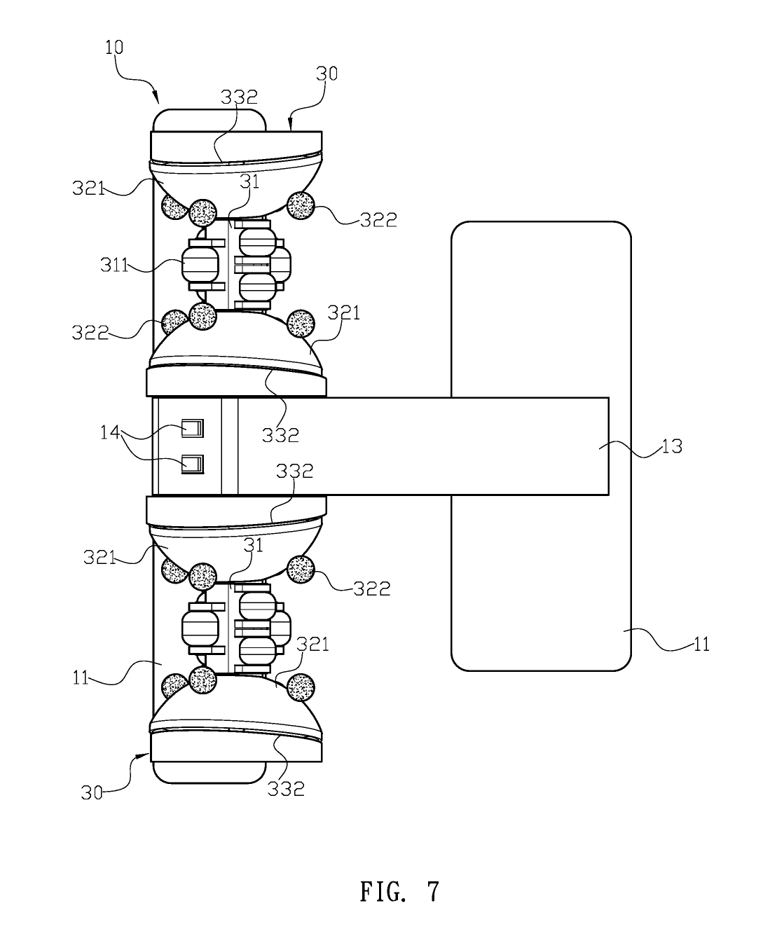

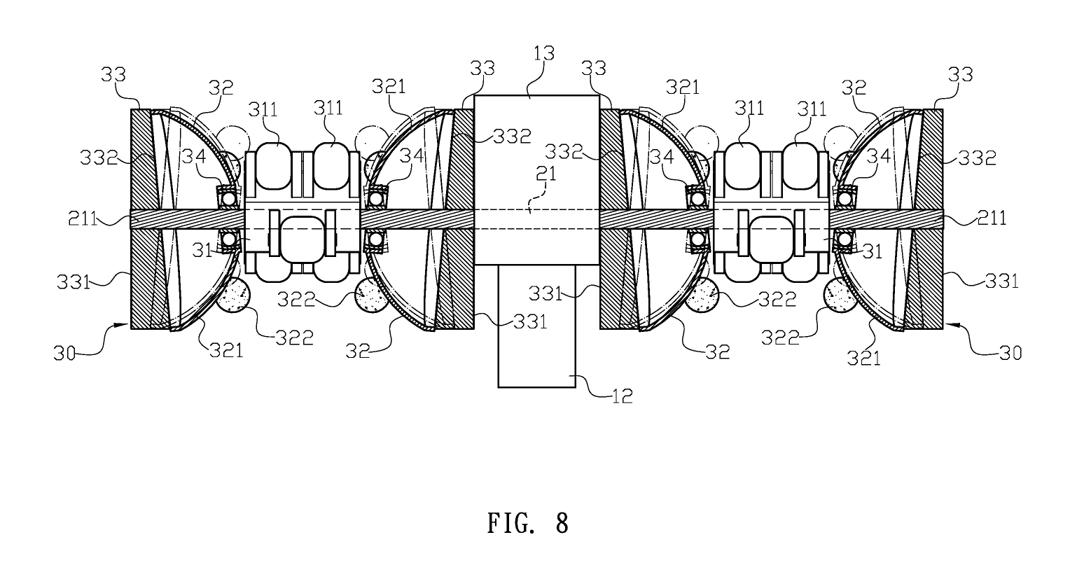

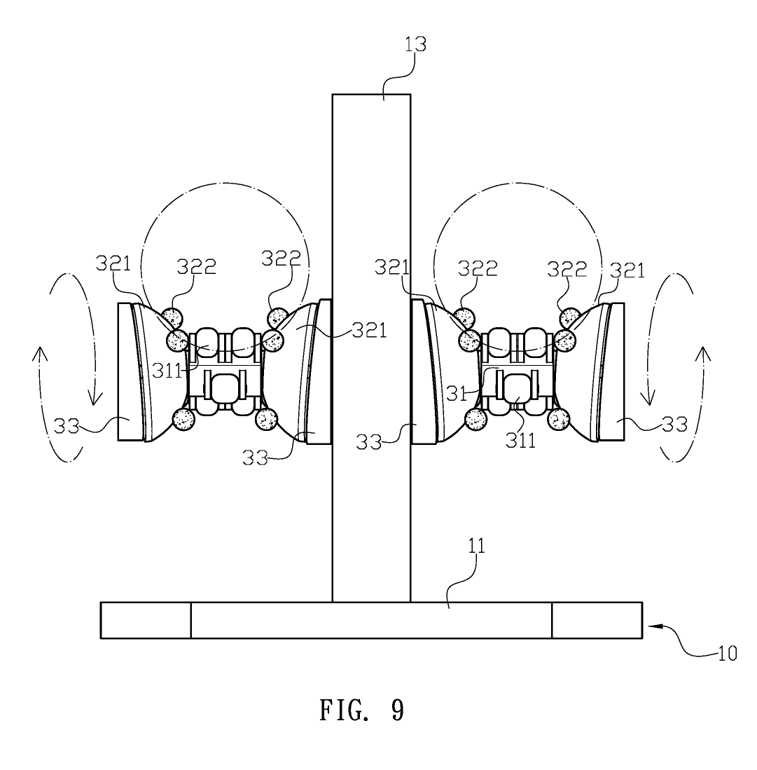

Therefore, it can prevent from hurting or injuring the users, and the comfort during massaging is enhanced. By means of the pivotally assembled bearing 34, the massaging disks 32 idle on the center shaft bar 21; when the center shaft bar 21 actuates the rotating bases 33 to turn, the inclined surfaces 332 of the rotating bases 33 press against the two massaging disks 32 on the same massaging component 30 to continuously swing offsetly (please refer to FIGS. 5 to 9). Therefore, the contacting surfaces 321 of the two massaging disks 32 can clamp and loosen alternatively to achieve finger-pressure kneading massage on human body.

The cyclical bicrural rolling and kneading massage device of the present invention has the following advantages: 1. the supporting frame 10 is not a massive bottom case that encloses the power unit 20 and the massaging components 30, and therefore, the cost of usage is low and does not occupy much space comparatively; 2. by means of the pivotally assembled rollers 311 and the rotating block 31, when the rotating block 31 is actuated by the center shaft bar 21 to rotate, the rollers 311 roll over the human body by turning freely instead of the design of directly rolling on the human body forcibly with the massage device, and therefore, it can prevent from hurting or injuring the users, and the comfort during massaging is enhanced; 3. the contacting surfaces 321 of the two massaging disks 32 on the same massaging component 30 are separated with the V-shape in between; the continuous offset swinging of the massaging disks 32 with the V-shaped contacting surfaces 321 can sequentially massage with a clamping pressure on the thighs, the low legs, the heels and even the soles of two legs, and therefore, the design is applicable to legs with different thicknesses; and 4. the two legs are kneaded with a clamping pressure by the offset swinging of the massaging disks 32, and thus the discomfort caused by the massaging disks 32 rolling over the human body forcibly can be avoided.

Note that the specifications relating to the above embodiments should be construed as exemplary rather than as limitative of the present invention, with many variations and modifications being readily attainable by a person of average skill in the art without departing from the spirit or scope thereof as defined by the appended claims and their legal equivalents.

What is claimed is:

1. A cyclical bicrural rolling and kneading massage device, comprising: a supporting frame, a power unit and two massaging components, wherein:
the supporting frame has a bottom portion, an upright column is protruded from a top of the bottom portion, and a hollow tubular rail column is mounted on the bottom portion, the rail column has a first end and a second end section, the first end and the second end section of the rail column are respectively linked to the bottom portion and a top end of the upright column so that the rail column is obliquely mounted between the upright column and the bottom portion, and a slot hole is penetratingly disposed on two sides of the rail column respectively;
the power unit is installed inside the rail column so that the power unit can operate upward and downward reciprocatively, or stop moving at any positions inside the rail column, the power unit is linked to a center shaft bar so that the center shaft bar is actuated to rotate continuously when the power unit is started, by the disposition of the slot hole, an assembling and connecting section disposed respectively at two ends of the center shaft bar can go through the rail column from the slot hole, the assembling and connecting section of each of the two ends of the center shaft bar is provided for installing one of the massaging components; and
each of the massaging components has a rotating block, and a plurality of rollers is pivotally disposed on an outer circumference of the rotating block, the rotating block is fixed at a center position of the assembling and connecting section so that the rotating block can move together with the center shaft bar, an eccentric element disposed outwardly from two sides of the rotating block respectively is sleevely assembled at a massaging disk on the assembling and connecting section, a rotating base fixed on the assembling and connecting section is disposed on an outer side of the two massaging disks respectively, a plane surface and an inclined surface are respectively disposed on two sides of the rotating base, the inclined surfaces of the two rotating bases on the same massaging component are maintained oppositely disposed, the inclined surface is provided for the massaging disk to press against, besides that the massaging disk can maintain at a predetermined eccentric angle by means of the inclined surface, a V-shape is formed between contacting surfaces of the two massaging disks, and can also prevent an oversized gap formed between the massaging disk and the rail column, a plurality of massaging dots is disposed on the contacting surface of the massaging disk, the two massaging disks of each of the massaging components are sleevely and pivotally assembled on the assembling and connecting section respectively by means of installing a bearing.

2. The cyclical bicrural rolling and kneading massage device as claimed in claim 1, wherein at least two switches are disposed on the second end section of the rail column, and the two switches are used to control the power unit to start or turn off, or stop moving at any positions, respectively.

3. The cyclical bicrural rolling and kneading massage device as claimed in claim 1, wherein a cross screw and a gear motor are coordinately disposed in the power unit, through the gear motor operating in a forward direction or a reverse direction, the gear motor can move upward and downward reciprocatively, or stop moving at any positions on the cross screw, and the gear motor is linked to the center shaft bar so that the center shaft bar is actuated to rotate continuously when the gear motor is started.

4. The cyclical bicrural rolling and kneading massage device as claimed in claim 1, wherein the massaging disk is a bowl-shaped structure so that the arcuate contacting surfaces of the two massaging disks on the same massaging component can maintain oppositely disposed.

5. The cyclical bicrural rolling and kneading massage device as claimed in claim 1, wherein the soft massaging dots are fixedly disposed on the contacting surface of the massaging disk.

6. The cyclical bicrural rolling and kneading massage device as claimed in claim 1, wherein a cloth cover is coupled between the two massaging disks of the same massaging component, and the cloth cover covers the two massaging disks and rotating block of the same massaging component.

7. The cyclical bicrural rolling and kneading massage device as claimed in claim 6, wherein a side of the cloth cover is turned over and then coupled with the massaging disk.

8. The cyclical bicrural rolling and kneading massage device as claimed in claim 1, wherein the bearing is an eccentric bearing.
